(19) United States
(12) Patent Application Publication
(10) Pub. No.: US 2023/0002245 A1
(43) Pub. Date: Jan. 5, 2023

(54) FILTER MEDIA, FILTER CARTRIDGE CONTAINING FILTER MEDIA, AND METHOD OF FILTERING WATER

(71) Applicant: PepsiCo, Inc., Purchase, NY (US)

(72) Inventors: Farshad KAMALI, Los Angeles, CA (US); Giancarlo FANTAPPIE, Rancho Palos Verdes, CA (US); Steven T. JERSEY, Laguna Niguel, CA (US)

(21) Appl. No.: 17/810,229

(22) Filed: Jun. 30, 2022

Related U.S. Application Data
(60) Provisional application No. 63/217,677, filed on Jul. 1, 2021.

(51) Int. Cl. C02F 1/00; C02F 1/48; B01D 27/06; B01D 39/16; B01D 39/20; B01D 36/02; C02F 1/68; B01D 27/14

(52) U.S. Cl. CPC C02F 1/003; C02F 1/48; B01D 27/06; B01D 39/1623; B01D 39/2017; B01D 39/2072; B01D 39/2031; B01D 36/02; C02F 1/688; B01D 27/144; B01D 27/146; C02F 2307/10; B01D 2239/0241; B01D 2239/025; B01D 2239/0407; B01D 2239/0618; B01D 2239/1216; B01D 2239/1241; B01D 2201/12; B01D 2201/186

(57) ABSTRACT

A filter medium for removing contaminants from water includes a matrix including a plurality of fibers having an electrostatic charge such that the matrix is configured to remove contaminants from water by electrostatic attraction. The filter medium further includes a filler material including a ceramic substrate containing a mineral. The filler material is embedded in the matrix. When water flows through the filter medium, the mineral at least partially dissolves in the water such that a cavity is formed in the matrix in a location of the at least partially dissolved mineral.

### CROSS-REFERENCE TO RELATED APPLICATION

This application claims the benefit of U.S. Provisional Application No. 63/217,677, filed Jul. 1, 2021, which is incorporated herein by reference in its entirety.

### FIELD

Embodiments described herein generally relate to filter media. Specifically, embodiments described herein relate to a filter medium that includes a matrix of fibers embedded with minerals that is configured to remove and trap contaminants from raw water using electrostatic forces and that increases the alkalinity of the water.

### BACKGROUND

The quality of drinking water may be evaluated based on the amount of total dissolved solids (“TDS”) in the water. Dissolved solids may include minerals, salts, metals, cations, or anions dissolved in water. TDS includes inorganic salts such as calcium, magnesium, potassium, sodium, bicarbonates, chlorides, and sulfates, and small amounts of organic matter. Such dissolved solids generally have a small size, e.g., below about 0.2 μm. The United States Environmental Protection Agency (EPA) has set the maximum contamination level of drinking water at a TDS of 500 parts per million (mg/L). However, good quality drinking water generally has a TDS of about 250 ppm or less.

The quality of drinking water may also be evaluated based on the amount of total suspended solids (“TSS”) in the water. Suspended solids may include, for example, silt particles, clay particles, plankton, algae, fine organic debris, and other particulate matter. Suspended solids may have a relatively large size of about 0.2 μm or greater. The national drinking water quality standard (NDWQS) for the maximum TSS in drinking water is 25 mg/L. Average quality tap water generally has a TSS of about 10 mg/L.

In order to improve the quality of drinking water, various types of filter media may be used to decrease the amount of TDS, TSS or both. There are a wide variety of filtration techniques and filter media for removing contaminants from water. Water filters may have a single stage with one filter or may include multiple stages having a combination of different filter media. Filter media may rely on different types of materials and may include mesh, screens, cloth, or membranes, among others. Filtration may be performed by surface filtration using a mesh or screen, or by depth filtration using a felt or cloth material. Filtration techniques include microfiltration, ultrafiltration, nanofiltration, reverse osmosis filtration, and ion exchange filtration.

Selection of filter media for use in a water filter may depend on a variety of design considerations. For example, a filter media may be selected based on the desired quality of the water, e.g., the desired level of TSS or TDS in the water, or to remove a particular contaminant from the water, e.g., viruses and bacteria. The filter media may be selected based on the cost to prepare the filter media, as certain materials and types of filters may be more expensive than others. Generally, the higher the purity of the drinking water desired, the higher the cost of the filter media. The filter media may be selected in order to optimize the expected useful life of the filter media as some applications may allow for easy replacement of the filter media such that a long useful life is not needed, whereas in other applications where the filter is difficult to clean or replace may be designed to provide a longer useful life. Further, the filter media may be selected based on the type of application of the water filter and the desired flow rate of water through the filter media, such as for commercial applications, e.g., in restaurants, for household use in a refrigerator or under-counter application, e.g., below a kitchen sink, or for personal use such as in a water pitcher or water bottle.

### SUMMARY OF THE INVENTION

Some embodiments described herein relate to a filter cartridge for a beverage dispenser that includes an outer housing comprising an inlet and an outlet, and a filter stage comprising a filter medium. The filter medium of the filter cartridge may include a matrix including a plurality of fibers having an electrostatic charge, and a filler material that includes a ceramic substrate containing a mineral, wherein the filler material is embedded in the matrix.

In any of the various embodiments described herein, the filter stage is configured to remove contaminants having a size in a range of 0.1 μm to 1 μm.

In any of the various embodiments described herein, the filter cartridge may further include a pre-filter stage arranged within the housing, wherein the filter stage is arranged downstream of the pre-filter stage. In some embodiments, the filter cartridge may include an inner housing arranged within the outer housing, wherein the pre-filter stage is arranged within the outer housing and the filter stage is arranged within the inner housing.

Some embodiments described herein relate to a beverage dispenser including a housing defining a beverage container receiving area, a dispensing head arranged on the housing for dispensing a beverage, and a filter cartridge as described herein, wherein the inlet of the outer housing of the filter cartridge is configured to receive water from a source of water, and the outlet of the outer housing of the filter cartridge is in communication with the dispensing head.

Some embodiments described herein relate to a filter medium for removing contaminants from water that includes a matrix including a plurality of fibers having an electrostatic charge such that the matrix is configured to remove contaminants from water by electrostatic attraction. The filter medium further includes a filler material including a ceramic substrate containing a mineral, wherein the filler material is embedded in the matrix. When water flows through the filter medium, the mineral at least partially dissolves in the water such that a cavity is formed in the matrix in a location of the at least partially dissolved mineral.

In any of the various embodiments described herein, the filter medium may be configured to remove suspended solids from water having a size in a range of 0.1 μm to 1 μm.

In any of the various embodiments described herein, the matrix may include a non-woven material that includes the plurality of fibers.

In any of the various embodiments described herein, the matrix may further include an additive configured to provide or enhance the electrostatic charge of the matrix. In some embodiments, the additive includes alumina.

In any of the various embodiments described herein, the plurality of fibers may include fibers selected from polypropylene, fiberglass, and nanofiber.

In any of the various embodiments described herein, the matrix may have a pore size in a range of 0.1 μm to 1 μm.

In any of the various embodiments described herein, the filler material may have a size in a range of 0.1 μm to 20 μm.

In any of the various embodiments described herein, the ceramic substrate may have a crystal structure.

In any of the various embodiments described herein, the mineral may be selected from magnesium, potassium, calcium, manganese, iron, zinc, phosphorus, and sodium.

In any of the various embodiments described herein, a solubility of the mineral may be about 1 mg/L to about 50 mg/L.

Some embodiments described herein relate to a method for filtering water containing contaminants using a filter medium, wherein the method includes flowing the water containing contaminants through the filter medium. The filter medium includes a matrix including a plurality of fibers having an electrostatic charge and a filler material including a ceramic substrate containing a mineral, wherein the filler material is embedded in the matrix. The method further includes trapping a first contaminant of the contaminants in the matrix of the filter medium by electrostatic attraction, and dissolving at least partially the mineral in the water flowing through the filter medium.

In any of the various embodiments described herein, the method may further include forming a cavity in the matrix as the mineral at least partially dissolves, and trapping a second contaminant in the cavity.

In any of the various embodiments described herein, the method may further include flowing the water containing contaminants through a pre-filter before flowing the water containing contaminants through the filter medium.

### BRIEF DESCRIPTION OF THE DRAWINGS/FIGURES

The accompanying drawings, which are incorporated herein and form a part of the specification, illustrate the present disclosure and, together with the description, further serve to explain the principles thereof and to enable a person skilled in the pertinent art to make and use the same.

FIG. 1 shows a diagram of a filter cartridge containing a filter medium as used in a beverage dispenser according to an embodiment.

FIG. 2 shows a perspective view of a layer of filter medium according to an embodiment.

FIG. 3 shows a magnified view of a non-woven filter medium according to an embodiment.

FIG. 4 shows an illustration of a matrix of a filter medium including an additive according to an embodiment.

FIG. 5 shows an illustration of an atomic structure of a filler material of a filter medium according to an embodiment.

FIG. 6 shows a close-up view of a portion of a filter medium according to an embodiment having pores formed from dissolution of filler material.

FIG. 7 shows a longitudinal cross-sectional view of a water filter comprising a filter medium according to an embodiment.

FIG. 8 shows a perspective view of a filter medium for use in a filter cartridge according to an embodiment.

### DETAILED DESCRIPTION OF THE INVENTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the claims.

Filters having multiple stages generally filter contaminants in order of decreasing size, with the smallest contaminants removed from the water in the final filter stage. As a result, the final filter stage is generally the rate-limiting stage of the filter in terms of the flow rate through the filter. A final filter stage that includes, for example, a mesh screen with sub-micron sized pores to separate contaminants based on size alone may not provide a desired flow rate of water through the filter unless high pressure is used to increase the flow of water through the filter. Further, the fine mesh screen may rapidly become blocked or clogged with contaminants and may need to be frequently cleaned or replaced, which is undesirable. As a result, it is desired to provide a filter media for removing sub-micron contaminants that maintains sufficient water flow rate and does not readily become clogged or blocked.

Additionally, filter media generally do not help to increase the alkalinity or pH of the water to “soften” the water. Adding minerals to water may help to improve the taste or quality of the drinking water. As a result, a filter media that removes contaminants from raw water and that also helps to increase the alkalinity or pH of the water to improve the quality and taste of the water is desired.

In some embodiments, a filter medium includes a matrix embedded with filler material including a ceramic substrate containing minerals that dissolve slowly over an extended period of time, such as on the order of one or more weeks or months. In this way, the filter medium may increase the alkalinity or pH of the water as the minerals dissolve into the water, and the slow rate of dissolution of the minerals may allow for the filter medium to provide consistent water quality over its useful life. In some embodiments, the filter medium may include a matrix of fibers having an electrostatic charge that is embedded with filler material that dissolves in the water resulting in formation of cavities in the matrix. As a result, formation of cavities in the matrix as the minerals dissolve helps to dynamically improve water flow by creating new flow channels through the filter medium, and the cavities may also serve to trap contaminants within the cavities by electrostatic forces.

As used herein, the term “contaminants” may refer to any of various substances or matter in water, including but not limited to suspended solids and dissolved solids, including for example, heavy metals, such as lead and mercury, chemical compounds and biomolecules, such as volatile organic compounds, chlorine, chloramine, pesticides, herbicides, pharmaceuticals, particulates, colloids, polysaccharides (TEP), cysts, bacteria, Legionella, E. coli, viruses, and endotoxins, among others.

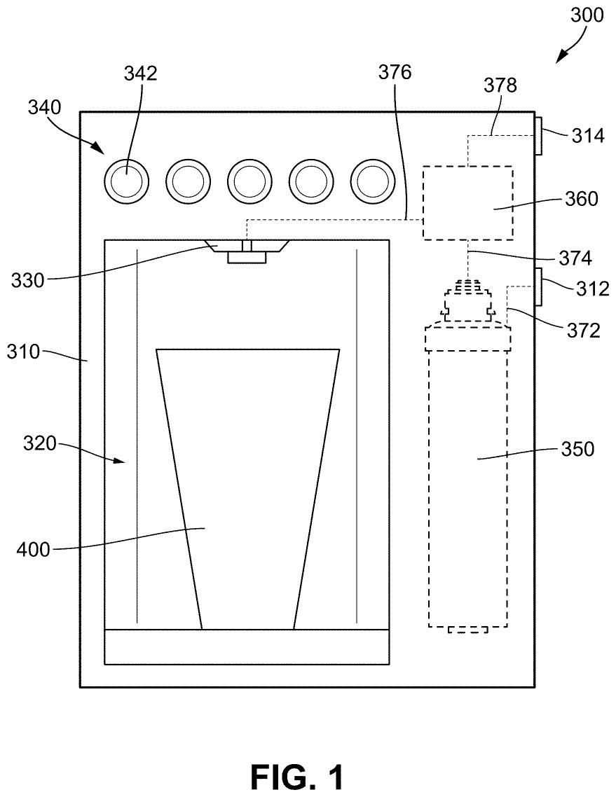

The filter medium described herein may be particularly suited for use in a home or office setting, such as in a refrigerator or a beverage dispenser 300, as shown for example in FIG. 1. While the filter medium is described herein in connection with a beverage dispenser, it is understood that the filter medium is capable of use in any of various settings or applications for removing contaminants from water.

In an exemplary embodiment, a beverage dispenser 300 may include a housing 310 defining a beverage container receiving area 320 in which a beverage container 400 may be placed. Beverage dispenser 300 may include one or more dispensing heads 330 for dispensing a beverage into a beverage container 400 placed in beverage container receiving area 320. Beverage dispenser 300 may further include a user interface 340 for receiving a selection of a beverage to be dispensed. User interface 340 may include, for example, a plurality of buttons 342 to be operated by a user by pressing a button 342 corresponding to the desired beverage. Beverage dispenser 300 may dispense any of various beverages, including for example, still water, sparkling water, cold water, hot water, or may dispense water in combination with a flavoring, sweetener, additive, or the like.

Beverage dispenser 300 may include a filter unit 350 containing a filter medium 100 as described herein for removing contaminants from water. In some embodiments, Filter unit 350 may include for example one or more filter cartridges, such as filter cartridge 200 described in further detail below. Beverage dispenser 300 may be connected to a source of water, such as a water line. Beverage dispenser 300 may include an inlet port 312 that communicates the water to an inlet of the filter unit 350, such as by an inlet line 372. Filter unit 350 removes contaminants from the water and the filtered water exits filter unit 350 via an outlet line 374 and may be dispensed by dispensing head 330.

In some embodiments, beverage dispenser 300 may include one or more water treatment units 360 for treating the filtered water prior to delivering the filtered and treated water to dispensing head 330 via a dispensing line 376. For example, a treatment unit 360 may include a heat exchanger or “chiller” configured to lower a temperature of the water, a heater configured to raise the temperature of the water, or a carbonator configured to carbonate the water, among others. Further, beverage dispenser 300 may include one or more sources of flavoring, or beverage dispenser 300 may be placed in communication with one or more sources of flavoring, such as via a flavoring inlet 314. Beverage dispenser 300 may include fluid lines 378 for communicating a flavoring from a source of flavoring to dispensing head 330, and treatment unit 360 may include a mixer or the like for combining the filtered water with the flavoring. Further, beverage dispenser 300 may include additional components, such as fluid lines, manifolds, pumps, valves, controllers, and sensors for measuring temperature or flow rate among other parameters, and other components as necessary for moving fluid through the beverage dispenser and operating the beverage dispenser as will be appreciated by one of ordinary skill in the art. Further, while filter unit 350 is shown upstream of treatment unit 360, it is understood that filter unit 350 may be arranged downstream of one or more of the treatment units 360 described above.

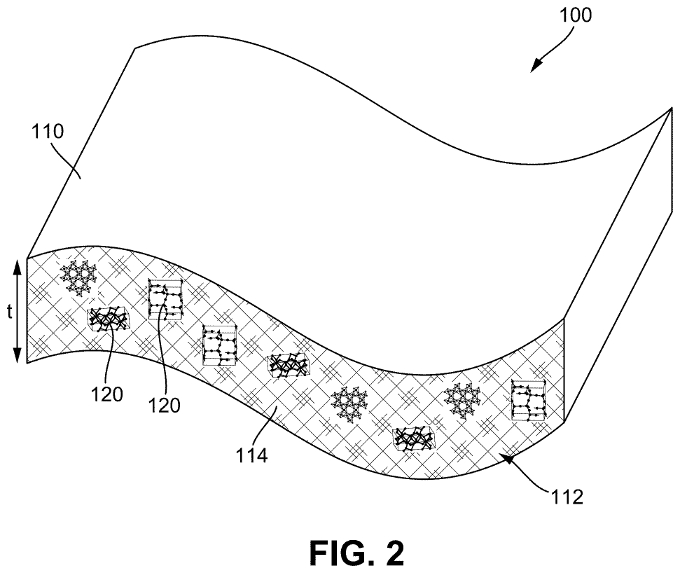

Some embodiments described herein relate to a filter medium 100 that includes one or more layers 110, as shown for example in FIG. 2. Each layer 110 of filter medium 100 includes a matrix 112 and filler material 120. Filler material 120 may be embedded in matrix 112. Filler material 120 may be distributed evenly throughout matrix 112 so that filter media 100 is substantially homogenous. Filter medium 100 may remove contaminants from water by blocking contaminants having a size greater than a pore size of filter medium 100 from passing through filter medium 100. Additionally, filter medium 100 may filter contaminants by adsorption of contaminants to matrix 112 by electrostatic forces.

In some embodiments, filter medium 100 may be configured to remove suspended solids and dissolved solids from water having a size in a range of about 0.1 μm to about 1 μm. Contaminants having a size greater than 1 μm may be removed from the water by a pre-filter, such as a carbon block, prior to flowing through filter medium 100. Removing contaminants having a size greater than 1 μm prior to flowing the water through filter medium 100 may further help to avoid clogging or blocking of filter medium 100 by such relatively large contaminants. Contaminants smaller than 0.1 μm, such as dissolved ions, may pass through filter medium 100 with little to no interaction due to their small size.

Each layer 110 of filter medium 100 may have a thickness t of 0.5 mm to 50 mm, 1 mm to 40 mm, or 2 mm to 30 mm. In some embodiments, filter medium 100 may have an average pore size of 0.1 μm to 1 μm. Filter medium 100 may remove contaminants having an average size greater than a pore size of filter media 100.

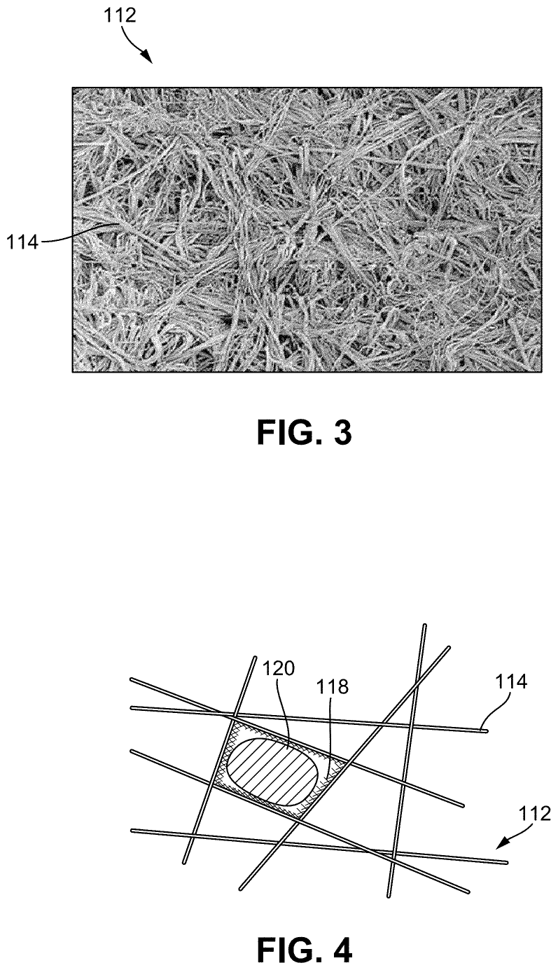

In some embodiments, matrix 112 of filter medium 100 may include a plurality of fibers 114. Filter medium 100 including a plurality of fibers 114 may be formed as a non-woven fabric, as shown for example in FIG. 3. Fibers 114 may include polypropylene fibers, fiberglass, nanofibers, or a mixture thereof.

Matrix 112 may have an electrostatic charge, such as a positive electrostatic charge. Many contaminants, such as bacteria and long-chain dissolved molecules, e.g., proteins may have a negative electrostatic charge and can be removed from water by electrostatic attraction to a filter medium 100 having a positive electrostatic charge. In this way, matrix 112 may trap contaminants, such as negatively charged contaminants by electrostatic attraction. As matrix 112 may trap contaminants based on electrostatic forces, matrix 112 may trap contaminants having a size that is smaller than a pore size of the matrix. The use of electrostatic forces to remove contaminants from water allows for filter medium 100 to have a lower pressure drop and higher flow rate than existing filter media that rely solely on small, micron or sub-micron sized pores to separate contaminants from the water.

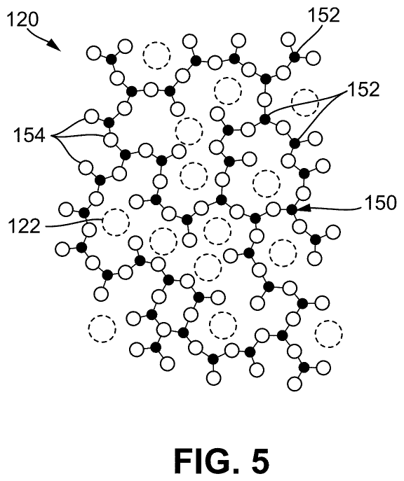

In some embodiments, matrix 112 may further include an additive 118, as shown for example in FIG. 4. Additive 118 may be configured to provide matrix 112 with an electrostatic charge or to enhance the electrostatic charge of matrix 112. Additive 118 may include for example, activated carbon or alumina. Additive 118 may coat or be embedded in fibers 114. Additive 118 may be in the form of a particulate or powder. In some embodiments, additive 118 may have an average size in a range of 0.01 μm to 10 μm. The additive 118 may be present in an amount of 1% to 50% of a volume of the fibers 114, 2% to 40% of a volume of the fibers 114, or 5% to 30% of a volume of the fibers 114.

Filter medium 100 may also include a filler material 120. Filler material 120 may be embedded in matrix 112. In some embodiments, filler material 120 may be present in filter medium 100 in an amount of about 1% to about 10% by volume. In some embodiments, filler material 120 may include minerals. Minerals may include alkaline minerals, such as sodium, potassium, calcium, manganese, magnesium, iron, zinc, phosphorus, or combinations thereof. Minerals may dissolve in water flowing through filter medium 100 in order to increase the pH or alkalinity of the water and to enhance the quality or taste of the water. However, minerals generally have a high solubility and dissolve rapidly in water. The inventors of the present application found that the solubility of minerals can be decreased such that the minerals dissolve more slowly over an extended period of time by incorporating the minerals into a ceramic substrate. In some embodiments, minerals of filler material 120 including a ceramic substrate may have a solubility of about 1 mg/L to about 50 mg/L, 2 mg/L to 30 mg/L, or 5 mg/L to 10 mg/L.

An exemplary filler material 120 including a ceramic substrate 150 is shown in FIG. 5. In some embodiments, ceramic substrate 150 may be formed, for example, from aluminum oxide (Al₂O₃), aluminate (AlO₄₋ₓ), or silicate (SiO₄₋ₓ), where x is 0, 1 or 2. As shown in FIG. 5, ceramic substrate 150 may include a network of aluminum (or silicon) 152 and oxygen atoms 154. In some embodiments, ceramic substrate 150 may have a crystal structure. Minerals 122 may be contained in the ceramic substrate 150. Minerals 122 may have a positive charge and may be bonded to ceramic substrate 150 by interaction with the negatively charged oxygen atoms of the ceramic substrate 150. The ceramic substrate 150 serves to cause the minerals 122 to dissolve slowly in the water flowing through the filter medium. Minerals 122 may dissolve over an extended period of time, such as several weeks or months. The solubility of the minerals can be tailored by adjusting the temperature and pressure used to form the filler material 120. The solubility may impact the useful life of filter medium 100, as a higher solubility may result in depletion of minerals 122 and of filter medium 100 more rapidly. Further, the solubility may impact the concentration of minerals 122 that dissolve into the filtered water, as the higher the solubility of minerals 122, the more minerals 122 will be dissolved from filter medium 100 into a given quantity of water.

In some embodiments, filter medium 100 may be configured to release a concentration of minerals similar to a concentration of suspended solids having a size of less than 1 μm in the water to be filtered. For example, if tap water to be filtered has a concentration of suspended solids with a size below 1 μm of about 5 mg/L, filter medium 100 may be configured to release about 5 mg/L of minerals as water flows through filter media 100. In this way, the dissolved minerals essentially replace the suspended solids removed from the water. However, it is understood that the rate at which minerals are released from filter medium 100 is independent of the rate at which contaminants are removed from the tap water flowing through filter medium.

In some embodiments, filler material 120 may have a size in a range of 0.1 μm to 20 μm, 0.1 μm to 15 μm, or 0.1 μm to 10 μm, wherein the size of the filler material 120 is an average of the maximum diameter of the filler material 120. In some embodiments, filler material 120 may be formed by grinding commercially available mineral ceramic balls, which may have a size of, for example, 1 mm to 5 mm, to the desired size, e.g., 0.1 μm to 20 μm. In some embodiments, filler material 120 may be formed by a sol-gel method which allows for formation of filler material 120 having a size of 1 μm or less.

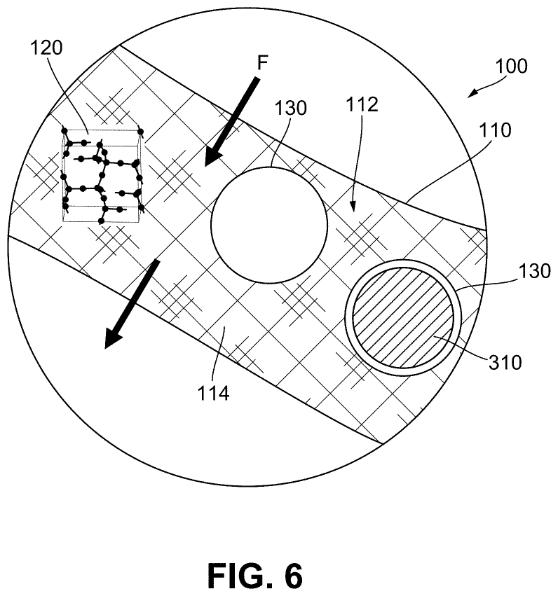

In operation of filter media 100, as water flows through filter medium 100, filler material 120 may begin to partially dissolve into the water, as shown for example in FIG. 6. As discussed, the minerals may dissolve in the water to increase the alkalinity or pH of the filtered water, softening the water and improving taste.

Additionally, as filler material 120 dissolves, cavities 130 are formed in matrix 112 in the space previously occupied by filler material 120. In this way, new flow paths through which water may flow through filter medium 100 are dynamically formed as minerals 122 dissolve. Formation of cavities 130 may help to maintain the flow rate of water through filter medium 100 throughout the useful life of filter medium 100. In some embodiments, cavities 130 may be formed at a rate of 0.0001 cm³ to 0.001 cm³ per liter of water flowing through filter medium 100.

Further, cavities 130 formed by dissolving of filler material 120 may trap suspended solids 410 within cavities 130. As cavities 130 are surrounded by electrostatically charged matrix 112, suspended solids 410 may become trapped within cavities 130 by electrostatic forces. When a filler material 120 is fully dissolved, cavity 130 has a size that is approximately a size of the filler material 120. Thus, in some embodiments, cavity 130 may have a size of about 0.1 μm to 20 μm. If the size of the cavity 130 is greater than about 20 μm, the electrostatic forces of matrix 112 may not be sufficient to attract and maintain sub-micron contaminants within cavity 130. Further, if cavity 130 is less than about 0.1 μm, contaminants may be too large to become trapped within cavity 130. Cavities 130 may trap suspended solids so as to avoid accumulation of suspended solids in matrix 112 which may otherwise block or clog filter medium 100.

Some embodiments relate to a method for filtering water containing contaminants using a filter medium. Water containing contaminants may flow through a filter medium that includes a matrix of a plurality of fibers having an electrostatic charge, and a filler material including a ceramic substrate containing minerals. The filler material may be embedded in the matrix of the filter medium. Contaminants may be trapped in the matrix of the filter medium by electrostatic attraction. As water flows through the filter medium, minerals may at least partially dissolve from the filter medium into the water. Cavities may be formed in the matrix of the filter medium as the minerals begin to dissolve. Contaminants may become trapped within the cavities by electrostatic forces. In some embodiments, the water may flow through a pre-filter prior to flowing through the filter medium in order to remove contaminants, such as contaminants having a size of 1 μm or greater.

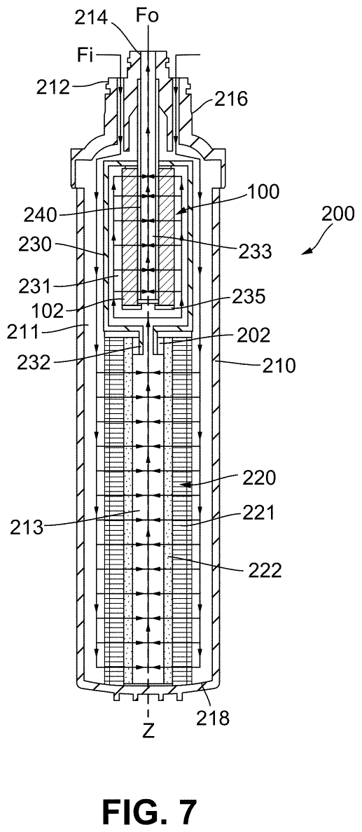

Filter medium 100 may be used as a filter stage in a filter cartridge 200, as shown in FIG. 7. Filter cartridge 200 may have one or more stages. Filter stages may include any of various filter media known in the art, such as polypropylene, activated carbon, catalytic carbon, kinetic degradation fluxion (KDF), natural fibers, synthetic fibers, hollow fibers, glass fibers, activated aluminum, manganese dioxide, stainless steel wire mesh, cellulose acetate membranes, polysulfone membranes, and reverse osmosis membranes, among others. Filter medium 100 may be used in one or more stages of filter cartridge 200, and may be used as a final stage of filter cartridge 200. Thus, filter medium 100 may be arranged downstream of one or more additional filter stages. In this way, filter medium 100 may increase the pH of the water and may enhance the water with minerals.

As shown in FIG. 7, filter cartridge 200 includes an outer housing 210 defining a hollow interior volume and having a first end 216 opposite a second end 218. In some embodiments, housing 210 may have a generally cylindrical shape. Outer housing 210 may define one or more inlets 212 through which water containing contaminants may flow into filter cartridge 200, and one or more outlets 214 through which filtered water may exit filter cartridge 200. In some embodiments, inlets 212 and outlets 214 may be arranged at first end 216 of housing 210. Outlet 214 may be arranged centrally and inlets 212 may be arranged peripherally on housing 210. In some embodiments, inlets 212 may be configured to allow water to flow into filter cartridge 200 along a longitudinal direction Z of filter cartridge 200, and outlet 214 may be configured to allow water to flow out of filter cartridge 200 in a longitudinal direction of filter cartridge 200.

Filter cartridge 200 may include a pre-filter 220 arranged within housing 210. Pre-filter 220 may include one or more filter stages 221, 222 and may include one or more types of filter media. For example, pre-filter 220 may include a carbon block, activated carbon, polypropylene or polyester, among others. In some embodiments, pre-filter 220 may be configured to remove contaminants having a size of 1 μm or greater. Pre-filter 220 may have a tubular configuration with an open central area. Filter stages 221, 22 of pre-filter 220 may be arranged concentrically in a nested configuration. Pre-filter 220 may be arranged parallel to longitudinal axis Z of housing 210 and may define a peripheral flow channel 211 in a space between pre-filter 220 and housing 210 and may define a central flow channel 213.

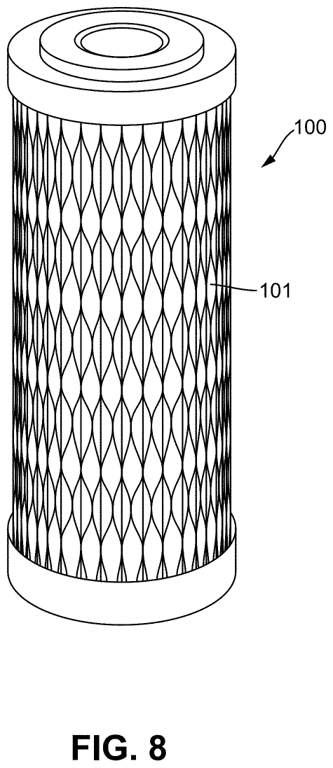

In some embodiments, filter medium 100 may also have a tubular construction with an open central area (see, e.g., FIG. 8). Filter media 100 may be arranged concentrically and nested within pre-filter 220. In some embodiments, as shown in FIG. 6, filter medium 100 may be arranged within an inner housing 230. Inner housing 230 may be arranged within outer housing 210 and may include an inlet 232 in communication with central flow channel 213 of pre-filter 220 such that water may flow from central flow channel 213 through inlet 232 into inner housing 230. Inner housing 230 helps to ensure water flowing into filter cartridge 200 through inlet 212 first flows through pre-filter 220 prior to reaching filter media 100. Further, as central flow channel 213 of pre-filter 220 may be relatively small, inner housing 230 may provide a larger volume within filter cartridge 200 in which filter media 100 may be arranged.

Filter medium 100 may be arranged within inner housing 230 to define a peripheral flow channel 231 between filter medium 100 and inner housing 230 and a central flow channel 233 in open central area of filter medium 100. Central flow channel 233 may be in communication with outlet 214 via an outlet tube 240. Outlet tube 240 may be arranged within open central area of filter medium 100.

In some embodiments, filter medium 100 may be pleated, as shown for example in FIG. 8. The use of pleats 101 helps to maximize the surface area of filter medium 100 in a given space, e.g., within inner housing 230 of filter cartridge 200 of FIG. 7. Increasing the surface area of filter medium 100 may help to increase filtration efficiency. Pleated filter medium 100 may have a surface area that is about 2 to 10 times greater than a surface area of filter medium 100 without pleats.

In some embodiments, pre-filter 220 may have a second end in contact with second end 218 of outer housing 210 and may extend toward first end 216 of filter cartridge 200. A first end of pre-filter 220 may be in contact with inner housing 230. A filter support 202 may support first end of pre-filter 220. In this way, water must flow through pre-filter 220 in order to reach inlet 232 of inner housing 230. A first end 102 of filter medium 100 may be attached to a first end of inner housing 230 and filter medium 100 may extend toward an opposing second end of inner housing 230 at which inlet 232 is arranged. Second end 103 of filter medium 100 may include a filter support 235. Filter support 235 may support and stabilize filter medium 100 and prevent water from flowing into open central area at the second end 103 of filter medium 100. In this way, water flowing into inner housing 230 flows through filter medium 100 to reach outlet 214 of filter cartridge 200.

In operation of filter cartridge 200, contaminated water may flow into filter cartridge 200 via inlets 212. Water may flow in peripheral flow channel 211 from first end 216 toward second end 218 of housing 210. Water may flow in a radial direction through pre-filter 220 into central flow channel 213 and pre-filter 220 may remove contaminants from the water, such as contaminants having a size greater than 1 μm. Water in central flow channel 213 may flow in a longitudinal direction toward first end 216 of outer housing 210 and into inner housing 230 through inlet 232. Water may be guided or deflected by filter support 235 to peripheral flow channel 231 in a longitudinal direction toward first end 116 of housing 210. Water may flow radially through filter medium 100 from peripheral flow channel 231 to central flow channel 233 and filter medium 100 may remove contaminants having a size in a range of 0.1 μm to 1 μm. Filtered water may then flow through an outlet tube 240 along longitudinal axis of filter cartridge 200 and through outlet 214.

Filter medium 100 and filter cartridges 200 as described herein may be used in any of various water filtration applications. Filter medium 100 and filter cartridges 200 as described herein may be particularly suited for point-of-use systems for treating water in a kitchen or bathroom sink, an appliance such as a refrigerator or beverage dispenser. Alternatively, filter media may be used in personal-use application, such as in a straw, a portable water filtration unit, a water bottle, a pitcher, or an emergency water filter. In some embodiments, filter medium 100 and filter cartridges 200 may be used in commercial settings, such as in a bar or restaurant for use in water coolers, hot water dispensers, coffee dispensers, flavored water dispensers, or soft drink dispensers, among others.

It is to be appreciated that the Detailed Description section, and not the Summary and Abstract sections, is intended to be used to interpret the claims. The Summary and Abstract sections may set forth one or more but not all exemplary embodiments of the present invention(s) as contemplated by the inventors, and thus, are not intended to limit the present invention(s) and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention(s) that others can, by applying knowledge within the skill of the art, readily modify and/or adapt for various applications such specific embodiments, without undue experimentation, and without departing from the general concept of the present invention(s). Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance herein.

What is claimed is:

1. A filter cartridge for a beverage dispenser, comprising:
an outer housing comprising an inlet and an outlet; and
a filter stage comprising a filter medium, wherein the filter medium comprises:
a matrix comprising a plurality of fibers having an electrostatic charge; and
a filler material comprising a ceramic substrate containing a mineral, wherein the filler material is embedded in the matrix.

2. The filter cartridge of claim 1, wherein the filter stage is configured to remove contaminants having a size in a range of 0.1 μm to 1 μm.

3. The filter cartridge of claim 1, wherein the filter medium is pleated.

4. The filter cartridge of claim 1, further comprising a pre-filter stage arranged within the housing, wherein the filter stage is arranged downstream of the pre-filter stage.

5. The filter cartridge of claim 4, further comprising an inner housing arranged within the outer housing, wherein the pre-filter stage is arranged within the outer housing and the filter stage is arranged within the inner housing.

6. A beverage dispenser, comprising:
a housing defining a beverage container receiving area;
a dispensing head arranged on the housing for dispensing a beverage; and
the filter cartridge of claim 1, wherein the inlet of the outer housing of the filter cartridge is configured to receive water from a source of water, and wherein the outlet of the outer housing of the filter cartridge is in communication with the dispensing head.

7. A filter medium for removing contaminants from water, comprising:
a matrix comprising a plurality of fibers having an electrostatic charge such that the matrix is configured to remove contaminants from water by electrostatic attraction; and
a filler material comprising a ceramic substrate containing a mineral, wherein the filler material is embedded in the matrix, and wherein the mineral is configured to at least partially dissolve when water flows through the filter medium such that a cavity is formed in the matrix in a location of the at least partially dissolved mineral.

8. The filter medium of claim 7, wherein the filter medium is configured to remove suspended solids from water having a size in a range of 0.1 μm to 1 μm.

9. The filter medium of claim 7, wherein the matrix comprises a non-woven material comprising the plurality of fibers.

10. The filter medium of claim 7, wherein the matrix further comprises an additive configured to provide or enhance the electrostatic charge of the matrix.

11. The filter medium of claim 10, wherein the additive comprises alumina.

12. The filter medium of claim 7, wherein the plurality of fibers comprises fibers selected from polypropylene, fiberglass, and nanofiber.

13. The filter medium of claim 7, wherein the matrix comprises a pore size in a range of 0.1 μm to 1 μm.

14. The filter medium of claim 7, wherein the filler material has a size in a range of 0.1 μm to 20 μm.

15. The filter medium of claim 7, wherein the ceramic substrate comprises a crystal structure.

16. The filter medium of claim 7, wherein the mineral is selected from magnesium, potassium, calcium, manganese, iron, zinc, phosphorus, and sodium.

17. The filter medium of claim 7, wherein a solubility of the mineral is about 1 mg/L to about 50 mg/L.

18. A method for filtering water containing contaminants using a filter medium, comprising:
flowing the water containing contaminants through the filter medium, wherein the filter medium comprises a matrix comprising a plurality of fibers having an electrostatic charge and a filler material comprising a ceramic substrate containing a mineral, wherein the filler material is embedded in the matrix;
trapping a first contaminant of the contaminants in the matrix of the filter medium by electrostatic attraction;
dissolving at least partially the mineral in the water flowing through the filter medium.

19. The method of claim 18, further comprising forming a cavity in the matrix as the mineral at least partially dissolves, and trapping a second contaminant in the cavity.

20. The method of claim 18, further comprising flowing the water containing contaminants through a pre-filter before flowing the water containing contaminants through the filter medium.
